(19) United States
(12) Patent Application Publication
(10) Pub. No.: US 2024/0403833 A1
(43) Pub. Date: Dec. 5, 2024

(54) REPAIR ORDER CREATION AND SYCRNOIZATOIN SYSTEMS AND METHODS

(71) Applicant: Highwater LLC, Plano, TX (US)

(72) Inventor: Jason K. PATZ, Plano, TX (US)

(21) Appl. No.: 18/327,270

(22) Filed: Jun. 1, 2023

(51) Int. Cl. G06Q 10/20

(52) U.S. Cl. CPC G06Q 10/20

(57) ABSTRACT

Systems and methods are provided for creating, synchronizing, and managing repair orders across a landscape of interconnected systems. Examples disclosed herein can provide for automated creation and/or correction of repair orders by applying a repair order creation model trained on acceptable and unacceptable repair orders to input repair order data. Furthermore, examples disclosed herein can compile repair order data and vehicle identifiers to generate a secured data structure for tracking service events rendered on the vehicle.

### BACKGROUND

Repair Orders, including physical and electronic repair orders, are physical or electronic records created during the course of rendering services and repairs on a vehicle. Repair Orders contain information for tracking personnel, facilities, tools, time spent, tests performed, expendable materials consumed, and parts used in performing the services and repairs. Generally, Repair Orders and Electronic Repair Orders are generally created by personnel and held in Dealership Management Software (DMS) and/or Shop Management Software (SMS) at, for example, automotive dealerships, independent repair shops, fleet service centers, and remote and independent service organizations, among others.

A Repair Order is typically created when a customer presents their vehicle for service and/or repair. Generally, the customer checks in with a Service Writer who initiates the Repair Order by documenting the Customer's complaint or concern (the “Complaint”). The Complaint can be provided as the customer's characterization of the problem with the vehicle for which service is being requested. The Repair Order is then assigned to a Service Technician who diagnoses the vehicle, documenting the diagnosis as one or more causes for the complaint (the “Cause”). The Service Technician then performs services to repair the Cause (the “Correction”). The Service Technician updates the Repair Order by documenting the Cause and the Correction. The Complaint, Cause, and Correction (referred to as the “3 C's”) collectively document the story of the service and/or repair performed on the vehicle.

The Repair Orders are referenced to make determinations on downstream business functions including, but not limited to warranty and insurance claims. For example, a Repair Order can be used to determine whether a service or repair qualifies for coverage under a warranty program, be it an Original Equipment Manufacturer (OEM) warranty or a third party (e.g., an aftermarket warranty), and/or qualifies for reimbursement under an insurance policy taken on the vehicle. The story, as documented by the 3 C's in a Repair Order, can be an integral part in making these determinations. For example, in the case of warranty claim, certain information must be included in the story in order for the warranty claim to be authorized. If the information is not included, or not provided in accordance with warranty processing policies, the warranty claim may not be approved, even though the service or repair may be of a type that would have otherwise qualified for a warranty submission. Similar situations occur when evaluating insurance claims as well.

As a result, Repair Orders need to be accessible for referencing by stakeholders and stakeholder systems external to a system that creates and stores Repair Orders. Further, it can be important to ensure that the stories are not only fully documented in Repair Orders, but also correctly documented according to any warranty programs and/or insurance policies that apply to vehicles on which service is performed.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example infrastructure, in which a repair order platform described herein may be implemented, according to embodiments disclosed herein.

FIG. 2 illustrates an example process flow for creating a Repair Order RO chain that can be used to track service events in accordance with embodiments disclosed herein.

FIG. 3A is a screen shots of an example unacceptable Repair Order.

FIG. 3B is a screen shots of an example acceptable Repair Order.

FIG. 4 is a schematic representation of an example system for generating a repair order creation model in accordance with an embodiment of the present disclosure.

FIG. 5 is a schematic block diagram of an operating environment for integrating a repair order platform with a repair order source system in accordance with embodiments disclosed herein.

FIG. 6 is an example computing component that may be used to implement various features of repair order management in accordance with the implementations disclosed herein.

FIG. 7 is flow diagram of an example process for generating repair orders in accordance with the implementations disclosed herein.

FIG. 8 is another example computing component that may be used to implement various features of repair order management in accordance with the implementations disclosed herein.

FIG. 9 is an example computer system that may be used to implement various features of repair order management of the present disclosure.

The figures are not exhaustive and do not limit the present disclosure to the precise form disclosed.

### DETAILED DESCRIPTION

Embodiments disclosed herein provide systems and methods for a centralized cloud-based platform for both managing and tracking Repair Orders (ROs) across a landscape of interconnected systems. The embodiments of the disclosed technology can synchronize ROs across RO source systems that generate ROs (such as, but not limited to, a DMS, a SMS, and the like) and external systems the utilize and rely on accurately documented ROs for providing further downstream services .or business functions. Furthermore, the disclosed technology can be configured to provide automated creation and/or correction of acceptable ROs, thereby ensuring that resulting ROs are both complete and correct for rendering downstream services reliant on the accuracy of ROs.

As used herein, “Repair Order”; “ROs”; and similar phrases refer to both physical and electronic ROs created during the course of rendering services and repairs on a vehicle by a servicing entity. As used herein, “service event” and similar phrases refers to an instance of rendering or otherwise performing a service and repair on a vehicle by the servicing entity. As used herein, “servicing entity” and similar phrases refers to an entity, business, person or the like that is providing for the service event and creates the RO. In the illustrative example of a servicing vehicles, servicing entity may refer to any of the following: automotive dealerships, independent repair shops, body shops, paint shops, fleet service centers, and remote and independent service organizations and technicians, among others.

As alluded to above, it can be important to ensure that stories documented in ROs through the 3 C's are not only fully documented, but also correctly documented according to any rules and polices for processing the ROs. These rules and polices may be ingested by the embodiments disclosed herein to create “processing routines”. The rules and policies for processing ROs may be defined by external stakeholders or stakeholder systems that process the ROs, such as, but not limited to, warranty claims, insurance reimbursement claims, and the like or other external routines that apply to vehicles on which service is performed. For example, in the case of a warranty claim, labor-time guides, defined by automotive OEMs and their respective warranty programs and processing systems, provide instructions on how to submit warranty claims and what information needs to be included to have the claim processed correctly (e.g., reimbursement provided to the servicing entity). Often, the labor-time guide defines codes that must be included in the RO for the servicing entity to be reimbursed. However, ROs are routinely created in haste by service rendering personnel (e.g., Service Technicians, Service Writers, etc.), who are time constrained and inconsiderate of needs to downstream rules and policies. As a result, language from one RO to another is often inconsistent; stories may be inaccurate, overly brief, lacking in necessary detail, ambiguous as to one or more of the 3 C's, or flat out incorrect; and the ROs may be refutable. These and other defects in ROs affect the downstream processing of ROs, in that services and repairs may not be covered under warranties, reimbursements under insurance policies may be denied, and so on. These downstream failures may have dire effects on repair shop and/or dealership revenue streams.

Furthermore, typically ROs are stored on disparate management systems, such as DMS, SMS, and the like (collectively referred to herein as RO source systems). These RO source systems may be specific to each entity. For example, a first dealership may operate a first DMS system, while a second dealership (same OEM or different) may operate a second DMS different from the first. Conventionally, these disparate RO source systems are not readily accessible to downstream stakeholders or stakeholder systems (e.g., warranty processing systems, insurance processing systems, and the like). Instead, the downstream stakeholder systems must rely on faxes, emails, or phone calls to collect the necessary information for processing claims and performing other downstream activities. As a result, along with the defects described above, the stakeholder systems may have to rely on a time consuming back and forth with servicing entities in order to process claims and other activities fully. Further still, without an ability to access past ROs or independently verify or certify ROs, the stakeholder systems are unable to track prior ROs and must rely on representations by the RO source system as to the authenticity and necessity of the service rendered corresponding to each RO.

Additionally, advances in electric vehicles Advanced Driver Assistance Systems (ADAS) and autonomous driving technologies have created a need to track and certify repairs across a vehicle's lifetime for risk, and compliance purposes. For example, technology advancements such as radar, adaptive cruise control, emergency braking systems, and the like, are systems that can in some cases require Certified Service Technicians to work on them, require certified facilities with proper testing and calibration equipment that too is calibrated correctly. Traditionally, all of the information for tracking the certifications and ensuring properly calibrated equipment is used in performing a service event are held in disparate systems that do not communicate directly with each other nor to downstream stakeholder systems. As a result, delays exist in ensuring certified repairs are performed correctly, or even confirming that the service event was certified at all. Furthermore, third party systems, such as Carfax®, government agencies, auction houses, etc., rely on a complete history of all service events, and confirmation of certified events for providing accurate vehicle histories and compliance records. That is, downstream stakeholders and these third party systems want to ensure, if the vehicle has been damaged in the past, that it had verifiable and certified repairs when appropriate.

Some systems have been developed that attempt to address some of the above short comings. One approach that has been attempted provides a stand-alone software package that can be used by Service Technicians to document stories for inclusion in an RO. However, this approach only offers suggestions to Service Technicians, and is agnostic to processing requirements of downstream stakeholder systems. That is, this approach does not consider rules, policies, or information required to ensure that the requirements of stakeholders are met. Instead, this approach offers suggestions based solely on the inputs. Accordingly, while a story may be completed using this approach, it still relies on the Service Technician (or other personnel of the servicing entity) to fill in missing information or add or correct information on which downstream process routines rely for rendering the downstream services. Furthermore, this approach requires an on-site installation or training process that presents a roadblock to adoption by Service Technicians, who are already disinterested in preparing ROs. Furthermore, this approach does not integrate with RO source systems, instead it relies on copying an improved Technician Story from the software package and pasting it into the RO source system.

As such, the technology disclosed herein provides technical solutions to the above described short comings of the conventional systems. Embodiments disclosed herein provide a centralized, cloud-based RO hosting platform, referred to herein as the “RO platform” or “RO Cloud platform”. The RO platform according to embodiments disclosed herein syncs RO source systems with external data sources, such as, downstream stakeholder systems and other third party databases utilized for data enhancement. For example, the RO source systems can be integrated with the RO platform, and, responsive to integration, the RO platform can scan and pull ROs from the RO source systems for hosting in a centralized database. Similarly, when an external system is integrated with the RO platform, the external system can then be provided access to the hosted ROs, through authentication techniques. As a result, downstream stakeholder systems (as well as other external systems) can have access the ROs to see and interact with the ROs in real time, such as responsive to an RO being created at the RO source system, to process the ROs. In some examples, responsive to an RO being created by the RO source system and stored in the RO platform, downstream stake holders that are impacted by the RO can be notified of or otherwise provided access to the RO. Further, downstream stakeholder systems can interact with RO source system during or after the RO's creation to proactively influence in creation and/or adjustment to the RO following its creation.

In an illustrative example, embodiments of the RO platform can serve as a centralized repository for ROs across a landscape of automotive or other industries that utilize ROs or have an ability to supplement and/or enhance RO data of an RO to enable processing routines that rely on said supplemented and/or enhanced RO data. The landscape can be made of one or more of Automotive Dealerships, Independent Repair Shops, Heavy Truck Dealerships, Motorcycle and Powersport Dealers, Boat and Watercraft Dealers, Aviation and Aircraft Dealers, OEM Warranty Processing Companies or Third-Party Administers (TPAs), Aftermarket Warranty Processing Companies or TPAs, or other products that require service/repair that have a similar process. Thus, while the embodiments discussed herein are made with reference to automotive industries, the scope of the present disclosure is not intended to be limited to only the automotive industry and may be applied to any industry that relies on ROs or their equivalents created at a service provider for use by a downstream stakeholder.

Embodiments of the disclosed technology can be integrated with existing systems, such as but not limited to RO source systems, for example by exposing application programming interfaces (APIs) to the existing systems and/or through over-the-air (OTA) programming integration into a vehicle itself, to include smart parts or other Internet of Things (IoT) parts/components on board a vehicle. In other embodiments, the disclosed technology can be used as a stand-alone software package for providing a mobile technician repair software that can be used to document repair work.

According to some embodiments, the RO platform can be configured to provide for automated creation and/or augmentation of ROs to output acceptable ROs by applying customized data processing onto RO data that is based on processing routines created for stakeholder systems defined by the rules and policies proprietary to the downstream stakeholder. The automated creation and/or augmentation of ROs may be driven by artificial intelligence (AI) that leverages a RO creation model trained to correct input RO data according to processing routines created from the rules and policies from downstream stakeholder systems.

As used herein, an “acceptable RO” and similar phrases refers to an RO that is both accurate and complete with respect to any processing routines applied to the RO for rendering downstream services, such as warranty claims, insurance reimbursement claims, and the like. That is, an acceptable RO is an RO that satisfies the rules and policies of downstream stakeholders that rely on the RO. As used herein, an “unacceptable RO” and similar phrases refers to an RO that is either inaccurate or incomplete with respect to processing routines applied to the RO for rendering downstream services. That is, an unacceptable RO is an RO that does not satisfy the rules and policies of downstream stakeholders that rely on the RO.

Embodiments of the RO platform disclosed herein construct a data structure that can be leveraged for tracking and confirming critical or certified service events across any number of service entities and locations according to an identifier that uniquely identifies a vehicle, such as vehicle identification number (VIN). For example, the RO platform can construct a blockchain type data structure, referred to herein as an RO chain, that can be used to track certified repairs. For example, when an RO is generated for a service event on a vehicle, the RO can be stored in association with the VIN for that vehicle and compiled into a block. The RO platform can verify the service event is a type that should be certified. Once verified, the block can be appended to a chain of ROs for association with the VIN. The chain of ROs can then be used to provide a history of all services and/or repairs rendered on the vehicle corresponding to the VIN, which can provide for both certification of ROs and tracking of repairs on the basis of a VIN. Furthermore, in some examples, when RO source systems are integrated with the embodiments disclosed herein, the ROs that are pulled from the RO source systems can be verified as to whether or not they are certified service events and append the certified ROs to the RO chain.

The RO chain provides aspects of a private and public permissionless system, allowing system operators to control who can access specific data stored in the RO chain, and what data will be available publicly. For example, private RO transactions and records may not be made public, but can be verified when needed, such as by allowing access through a smart contract built into the RO chain for a VIN. Confidential information may be kept inside the RO platform, while remaining verifiable by third parties. For example, an external system may own or interact with an RO, or RO chain, but may not be permitted to alter information contained therein. In some implementations, external systems may only be permitted to append the RO chain by adding one or more blocks for new ROs. Further, the RO chains can provide a “chain of custody” of ROs starting with the RO source system (e.g., from a Service Writer) and ending at a downstream stakeholder.

Embodiments disclosed herein provide several technical advantages over conventional approaches to the RO creation and processing methods. For example, dealers and downstream stakeholders generally hire tens of thousands of Warranty Administrators, which requires significant costs on the order of billions of dollars annually to interface with Service Technicians for fixing unacceptable ROs and properly documenting stories in order to correctly process OEM and aftermarket warranty claims. Further, service entities, particularly dealerships, generally receive OEM Scorecards that are dependent on acceptable ROs. A less than acceptable RO, can result in inferior OEM Scorecard resulting in increased compliance and documentation demands asserted by the OEM on the service entity, as well as increasing exposure to audits and paid claim chargebacks. Thus, embodiments herein can be implemented to reduce these costs and improve OEM scorecards through the automated creation or correction of acceptable ROs as described above, thereby reducing, if not fully avoiding, the creation of unacceptable ROs.

As another example of an advantage over conventional systems, the advancing of technology in vehicles requires verification of critical or certified repairs that cannot be verified or tracked to a VIN using the conventional systems without considerable manual research into the disparate service points on a vehicle over its lifetime. By providing the ability to track certified repairs through RO chains, downstream stakeholders can be granted access to certified service events for processing the ROs, detecting service and/or RO fraud, and understanding the service history of a vehicle over its lifetime. For example, a Service Technician may document in an RO that they spent more time on servicing a vehicle repair than they actually did, or more time than permitted for the service event according to the labor-time guide. This may be done to permit a customer to keep a rental car for a longer period of time until the customer can pick up their vehicle. In this case, the service event may have actually taken 4 hours, but the RO may indicate 2 days to permit the extra time. The RO chain according to embodiments disclosed herein may be used to protect against this fraud, for example, by providing a verified historical tracking of chained ROs that a warranty or insurance processor can review to confirm (1) that the repairs are as expected and (2) that the rental car allotment corresponds properly to the service RO and actual amount of time serviced.

As another illustrative example, assume a customer was in a first accident two years ago and received an insurance payout for the first accident. The customer may have elected to do some of the repairs (e.g., replace the bumper), but not all repairs (e.g., replacing a sway bar, control arm, ball joint, etc.). Later, the vehicle is in a second accident and a new insurance claim is submitted. The insurance company may receive the new claim, but some of the damage may actually be unrepaired damage from the first accident. The insurance company can access the RO chain for the VIN and see that only the bumper was replaced after the first accident. Recognizing that certain damage is from the first accident, which the insurance company already paid for, the claim can be rejected or partially reimbursed for that damage resulting from the second accident.

Conventional systems fail to provide for this visibility into historical service events or tracking of prior servicing and repairs. That is, conventional systems fail to provide for a centralized repository that pulls information together, certifies that ROs are correct from all of these distributed locations, and then provides access to the information for review and/or modification.

As yet another example advantage over the conventional systems, generally Fleet Service Centers perform warranty repairs on their own avoiding dealership service centers due to long wait times so that Fleet Vehicles may be returned to service quickly. The Fleet Service Centers generally lack the ability to file warranty claims with the OEM because they are unable convert their ROs into OEM Compliant ROs for the purpose of a Warranty Claim submission. For example, generally, SMS operated by Fleet Service Centers are not integrated or otherwise connected to OEM systems for submissions of Warranty Claims. Embodiments disclosed herein can provide for automated RO compliance within fleet organizations for submission for warranty reimbursements, which can be accessed on the RO platform by the Warranty Administrators or Warranty Processing Companies, in order to submit warranty claims on behalf of the fleet organization.

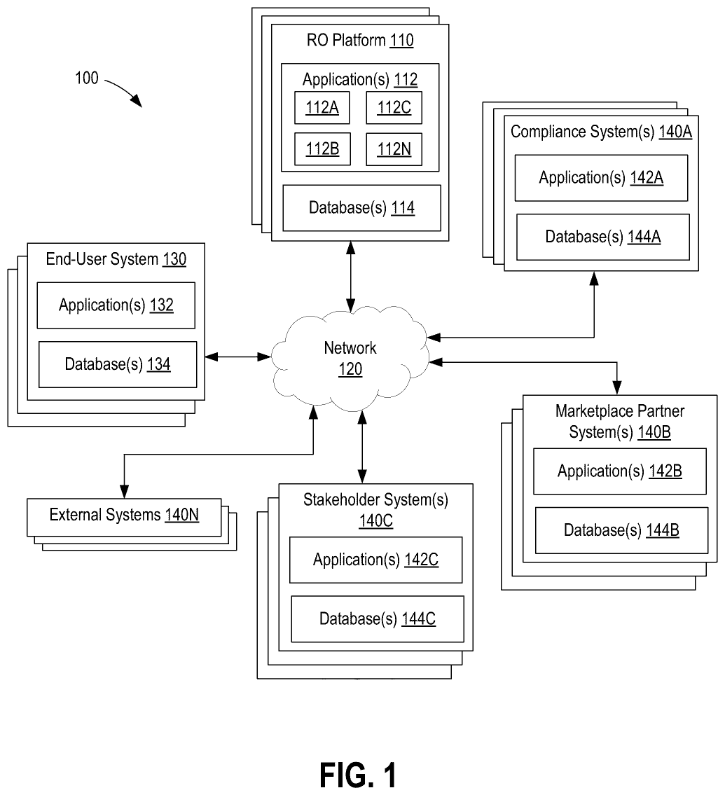

FIG. 1 illustrates an example infrastructure 100 in which the disclosed technology may operate, according to embodiments disclosed herein. The infrastructure 100 may comprise a RO platform 110 that performs one or more of the various functions, processes, and/or methods described herein. RO platform 110 may be hosted by one or more servers, such as dedicated servers, or may instead comprise cloud instances, which utilize shared resources of one or more servers. These servers or cloud instances may be collocated and/or geographically distributed. RO platform 110 may also comprise or be communicatively connected to application(s) 112 and/or one or more databases 114. In addition, RO platform 110 may be communicatively connected to one or more end-user systems 130 via one or more networks 120. RO platform 110 may also be communicatively connected to one or more external systems 140A-140N (collectively referred to herein as external systems 140) via one or more networks 120.

Network(s) 120 may comprise a wired or wireless communication interface, and RO platform 110 may communicate with end-user system(s) 130 through the Internet over one or more networks 120 using standard transmission protocols, such as HyperText Transfer Protocol (HTTP), Secure HTTP (HTTPS), File Transfer Protocol (FTP), FTP Secure (FTPS), SSH FTP (SFTP), and the like, as well as proprietary protocols. While RO platform 110 is illustrated as being connected to various systems through a single network 120, it should be understood that RO platform 110 may be connected to the various systems via different sets of one or more networks. For example, RO platform 110 may be connected to a subset of end-user systems 130 and/or external systems 140 via the a first network (e.g., a wireless communication network), but may be connected to one or more other end-user systems 130 and/or external systems 140 via a wired or short range network. Furthermore, while only a single end-user system 130 and a few external systems 140, one server application 112, and one set of database(s) 114 are illustrated, it should be understood that the infrastructure may comprise any number of user systems, applications, and databases.

End-user system(s) 130 may comprise any type or types of computing devices capable of wired and/or wireless communication, including without limitation, desktop computers, laptop computers, tablet computers, smart phones or other mobile phones, wearable mobile devices, servers, televisions, set-top boxes, electronic kiosks, and the like. Such end-user system(s) 130 may be, for example, RO source systems. RO source systems may be front-end systems that are operated by end-users at, for example but not limited to, dealerships, independent repair shops, fleet service centers, mobile repair application software, and the like. End-user system(s) 130 may be implemented as DMS, SMS, or other systems for creating ROs. End-users of end-user system(s) 130 may include, for example, Service Writers, Service Technicians, and any other personnel involved in the rendering of services and/or repairs to a vehicle. In some embodiments, an end-user may be a system administrator, such as a Warranty Administrator, or the like.

External systems 140 may comprise any type or types of computing devices capable of wired and/or wireless communication, including without limitation, connected vehicles, smart or connected parts or components within the vehicle, desktop computers, laptop computers, tablet computers, smart phones or other mobile phones, wearable mobile devices, servers, televisions, set-top boxes, electronic kiosks, and the like. Such external systems 140 may be, for example, downstream stakeholder systems. Examples of downstream stakeholders include, but are not limited to, insurance companies and/or TPAs that process insurance claims, OEMs, TPAs and/or aftermarket manufacturers that process warranty claims, OEMs and Supply chain partners, NHTSA/government agencies, vehicle history reporting companies (e.g., CarFax® and the like), marketplace partners (e.g., Amazon® automotive, Hertz or other vehicle rental companies, auction house companies, pre-purchase inspection requests, etc.).

For example, as shown in FIG. 1, stakeholder systems 140C may represent systems corresponding to one or more downstream stakeholders whose rules and policies define processing routines for processing claims related to service events (e.g., warranty claims, insurance claims, and the like). Downstream stakeholders may refer, for example but not limited to, to insurance companies and/or TPAs that process insurance claims and OEMs, TPAs and/or aftermarket manufacturers that process warranty claims.

Compliance system 140A may represent one or more compliance monitoring and/or vehicle history reporting systems operated by, for example, OEMs and Supply chain partners, NHTSA/government agencies, vehicle history reporting companies (e.g., CarFax® and the like). Compliance system 140A may provide an interface for compliance and vehicle history reporting systems to access ROs for tracking work performed on vehicles, according to VIN, for ensuring compliance with regulations, updating vehicle history reports, and the like. Furthermore, compliance system 140A may rely on accurate representation and reporting of certified service events to ensure compliance and to accurately track service events on a vehicle.

Marketplace partner systems 140B may represent one or more marketplace partner entities, such as Amazon automotive, vehicle rental companies, auction house entities, vehicle inspection companies, and the like. Marketplace partner systems 140B may provide an interface through which marketplace partners can access services provided by RO platform 110. These marketplace partner systems 140B may access RO platform 110 for tracking trends and ROs for further assisting with the service events of a vehicle. For example, certain incidents may require servicing and repair from a number of service entities. In an illustrative example, a vehicle may be in accident that results in both mechanical damage and vehicle body damage. A dealership may be able to do the mechanical work, and may need to sublet or sub-contract the body work. In this case, the dealer may create an RO for the mechanical work, which is uploaded to the RO platform 110. The RO may include an information on the body work, for example, in the Cause or the Complaint portions of the RO. One or more sub-contractors, for example, on Amazon Automotive or the like, can access the RO on the RO platform 110 and offer to perform the body work, or provide parts, components, testing or other elements of the repair. Neither the dealer nor the customer needs to shop around for a sub-contractor as the RO platform 110 provides for automated means for accessing marketplace partners to perform this work.

RO platform 110 may comprise web servers which host one or more websites and/or web services. In embodiments in which a website is provided, the website may comprise one or more user interfaces (UI), including, for example, webpages generated in HyperText Markup Language (HTML) or other language. RO platform 110 transmits or serves these UI in response to requests from end-user system(s) 130. One or more features and functionalities of the RO platform 110 can be exposed via the UI, which may be accessed by an end-user. The requests to RO platform 110 and responses from RO platform 110, including the UIs, may be communicated through network(s) 120. These UI or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to RO platform 110. RO platform 110 may also respond to other requests from end-user system(s) 130, compliance systems 140A, stakeholder systems 140C, marketplace partner systems 140B, and/or other external systems 140.

RO platform 110 may further comprise, be communicatively coupled with, or otherwise have access to one or more database(s) 114. For example, RO platform 110 may comprise one or more database servers which manage one or more databases 114. A end-user system(s) 130 or application 112 executing on RO platform 110 may submit data to be stored in database(s) 114, and/or request access to data stored in database(s) 114. ROs can be stored to database(s) 114 as RO data, which contains the data entered by an RO source system. RO platform 110 may tag the RO data with a location identifier that identifies the source of RO data, such as an identifier of the an end-user system 130 that generated the RO and/or unique identifier of the entity that created the RO (e.g., a dealer, shop, etc.). The RO data may also comprise a timestamp of when the RO data is stored at database(s) 114. Any suitable database may be utilized, including without limitation Vector, MySQL™, Oracle™, IBM™, Microsoft SQL™, Sybase™, Access™, and the like, including cloud-based database instances and proprietary databases. Data may be sent to RO platform 110, for instance, using the POST request supported by HTTP, via FTP, etc. This data, as well as other requests, may be handled, for example, by server-side web technology, such as a servlet or other software module (e.g., applications 112), executed by RO platform 110.

In embodiments in which a web service is provided, RO platform 110 may receive requests from one or more external system(s) 140 and end-user system(s) 130, and provide responses in, for example, extensible Markup Language (XML) and/or any other suitable or desired format. In such embodiments, RO platform 110 may provide an application programming interface (API) which defines the manner in which end-user system(s) 130 and/or external system(s) 140 may interact with the web service. Thus, end-user system(s) 130 and/or external system(s) 140 (which may themselves be servers), can define their own UIs, and rely on the web service to implement or otherwise provide the backend processes, methods, functionality, storage, etc., described herein. For example, in such an embodiment, a client application 132 executing on one or more end-user system(s) 130 as a frontend process may interact with one or more applications 112A-112N executing on RO platform 110 to execute one or more or a portion of one or more of the various functions, processes, methods, and/or software modules described herein. Client application 132 may be “thin,” in which case processing is primarily carried out server-side by application 112 on RO platform 110. A basic example of a thin client application is a browser application, which simply requests, receives, and renders webpages at end-user system(s) 130, while the application(s) 112 on RO platform 110 is responsible for generating the webpages and managing database functions. Alternatively, the client application 132 may be “thick,” in which case processing is primarily carried out client-side by end-user system(s) 130. It should be understood that client application 132 may perform any amount of processing, relative to application(s) 112 on RO platform 110, at any point along this spectrum between “thin” and “thick,” depending on the design goals of the particular implementation. In any case, the applications described herein, which may wholly reside on either RO platform 110 (e.g., in which case application 112 performs all processing) or end-user system(s) 130 (e.g., in which case application(s) 132 performs all processing) or be distributed between RO platform 110 and end-user system(s) 130 (e.g., in which case application(s) 112 and client application(s) 132 both perform processing), can comprise one or more executable software modules that implement one or more of the processes, methods, or functions of the application(s) described herein.

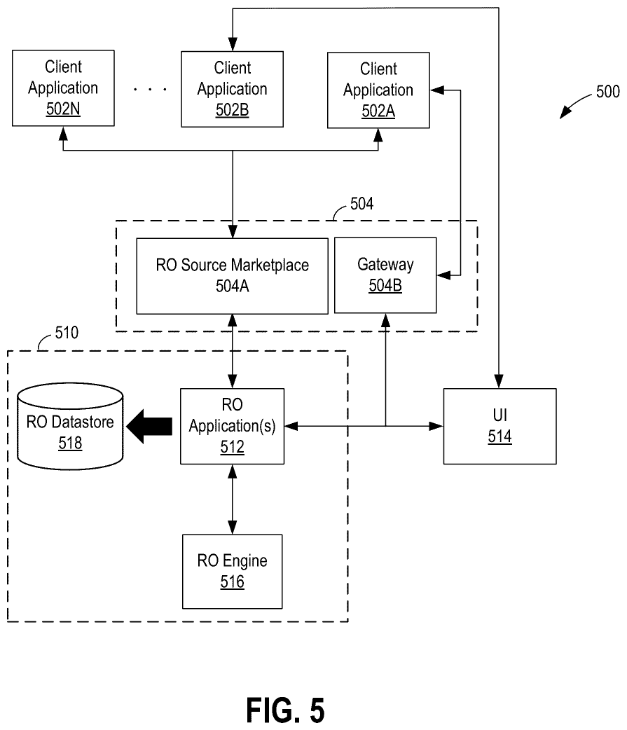

According to various embodiments disclosed herein, RO platform 110 provides a centralized, cloud-based platform for hosting RO data. The RO platform 110 according to embodiments disclosed herein can synchronize with end-user system(s) 130 executed as RO source systems as well as external systems 140. Embodiments of the disclosed technology can be integrated with existing systems, such as but not limited to end-user system(s) 130, for example by exposing application programming interfaces (APIs) to the existing systems and/or through over-the-air (OTA) programming integration into a mobile device and/or vehicle itself, for example, as described below in connection with FIG. 5.

Responsive to integration with end-user system(s) 130, the RO platform 110 can retrieve ROs stored in the end-user system(s) 130. The obtained ROs can be committed the ROs to database(s) 114, thereby creating a central repository for ROs. In some embodiments, the ROs can be processed to ensure they are acceptable ROs and, if they are unacceptable, modified so to make them acceptable, for example, through the RO cleaner function described below. ROs may be grouped according to a unique identifier, such as a VIN identifying a vehicle for which the RO corresponds.

Similarly, when an external system 140 is integrated with the RO platform, the external system 140 can be provided access to the repository of ROs. As a result, external systems 140, such as stakeholder systems 140C, can have access to the ROs for use in executing processing routines. The external systems 140 may have access in real time, as ROs are created by an end-user system 130 and stored to database(s) 114. In some examples, responsive to an RO being stored in the RO platform 110, external systems 140 that are impacted by or otherwise interested in the RO can be notified of or otherwise provided access to the RO. For example, an RO may include identification of a stakeholder, and responsive to storage to database(s) 114, RO platform 110 may generate a notification that the RO is available and forward the notification to the stakeholder system 140C for that stakeholder. In another example, the RO itself may be forwarded to the stakeholder systems 140C for review. In various embodiments, external systems 140 can query RO platform 110 to determine if an RO exists for a VIN, for example, by transmitting a query request packaged with a VIN.

RO platform 110 comprises a plurality of applications 112A-112N, each of which can be executed to provide a functionality of the RO platform 110. Application 112A may be executed to build an RO chain corresponding to a unique identifier that operates to certify and secure (or lock) the data of ROs such that the RO data cannot be altered. The RO chain can provides aspects of a private and public permissionless system, allowing system operators to control who can access specific data stored in the RO chain, and what data will be opened up publicly. Application 112B may be executed for automated RO creation that provides for creating ROs in real-time according to end-user inputs. Application 112C may be executed for automated RO correction that augments and corrects a previously documented RO supplied to the application 112C as an input.

Applications 112A-112N may be embodied as one or more software modules that can be executed by one or more hardware processors. These applications which may be executed wholly by one or more servers, wholly by end-user system(s) 130, or may be distributed across servers and end-user system(s) 130 such that some portions or modules of the application are executed by a server and other portions or modules of the application are executed by end-user system(s) 130. The described functions performed by the applications 112A-112N may be implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems.

In some embodiments, RO platform 110 can be configured to modify the RO as permitted by the end-user system(s) 130. These adjustments include, but are not limited to, inserting flags into ROs, changing a status of an RO, and inserting comments or annotations into an RO. These adjustments can be provided to end-user system(s) 130 or external systems 140 from RO platform 110 and/or can be viewed through an web service or portal. Further, RO platform 110 can be configured to allow external systems 140 to inform end-user system(s) 130 that additional information, corrections, or other changes are required or requested of an RO through, for example, flagging, status changes, and/or comments.

According to an example, an RO can be flagged by inserting one or more flags into RO data stored in database(s) 114. The flag may be used as a way of making end-user system(s) 130 aware that there is a need for action on the RO. In some embodiments, the flag may be generated by RO platform 110 based on inputs from stakeholder systems 140C. For example, stakeholder systems 140C may indicate that processing was unable to be completed due to an RO being unacceptable, and RO platform 110 may flag the RO responsive to the input and forward the flagged RO to the end-user system(s) 130 for corrective action. In another example, RO platform 110 may flag the RO based on executing one or more of application 112A-112N. For example, after executing application 112B, RO platform 110 may be unable to correct the RO. As a result, RO platform 110 may be flag the RO for corrective action by the end-user system(s) 130.

In some embodiments, each RO may be associated with a status, for example, through a status identifier contained in the RO data. RO platform 110 may be configured to change the status of the RO stored in database(s) 114 and push the status change to ROs on the end-user system(s) 130. Furthermore, any data element of an RO can be changed in an RO Source System, not just the status. The change of the status identifier may be a way of notifying end-user system(s) 130 that an RO requires a change before further processing can be completed. By changing the status identifier, the status can be updated in to prevent the RO from advancing to a next stage of processing at the servicing entity before the stakeholder concerns related to the status change is corrected. Stakeholder systems 140C that review the RO can flag the RO and add comments thereto and/or change the status as necessary to inform RO platform 110 and end-user system(s) 130 of the concerns. Example status identifiers include, but are not limited to, “Information Requested”, “Incomplete”, “Corrected Information Required”, “Information Verification Required”, “Marketplace Partner Offer Available,” etc. As an example, a servicing entity may close an RO in the corresponding end-user system 130, but an insurance company input may modify a status identifier of the RO to “Information Requested”, which RO platform 110 can use to notify the servicing entity that additional information is required for the RO to be properly processed. In this regard, an insurance company may input the status change into stakeholder systems 140C, which communicates the change to RO platform 110. Infrastructure 100 may update the status identifier associated with the RO in database(s) 114, which triggers a notification to the end-user system 130 that sourced the RO.

In some embodiments, when an RO is flagged or its status is changed, RO platform 110 may add a comment to the RO, which can be used to inform end-user system(s) 130 that additional information and/or corrections are being requested from a stakeholder systems 140C prior to the RO advancing to a new status. For example, similar to the above, stakeholder systems 140C may be used to input comments and/or annotations on an RO, which RO platform 110 can add to the RO within database(s) 114. The comments and annotations can then be provided to end-user system(s) 130 for responding to.

In some embodiments, a user can request the RO platform 110 to alert the users responsive to flags and/or comments that are added to an RO. In some implementations, the user may request to have messages dispatched by RO platform 110 through the integration, email, text messages (e.g., SMS or the like), or other messaging preference.

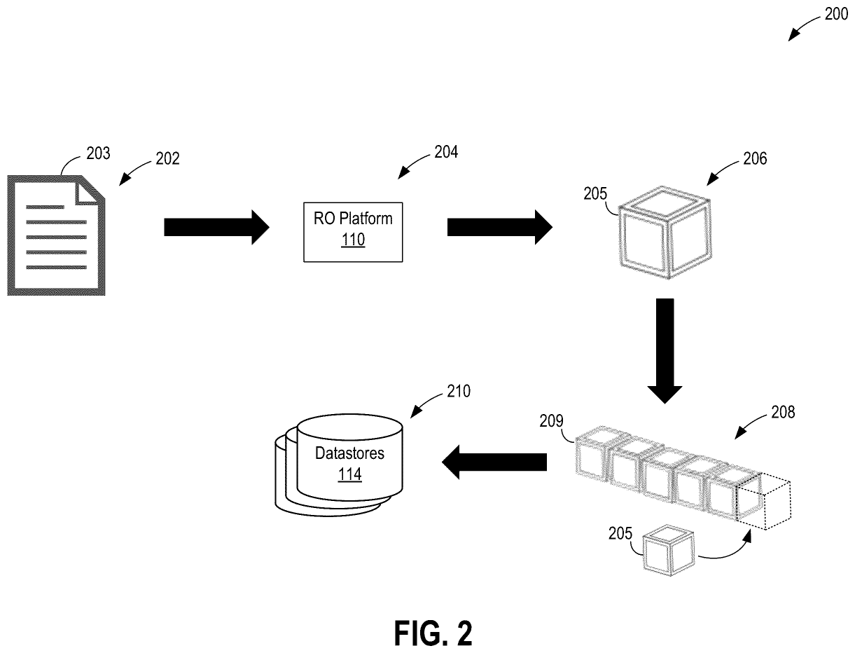

As alluded to above, application 112A may be executed to create RO chains that can provide for tracking and certification of service events according to VINs across any number of service points. FIG. 2 illustrates example process flow 200 for creating an RO chain in accordance with embodiments disclosed herein. Process flow 200 may be implemented as instructions, for example, stored in a memory, that when executed by one or more processors perform one or more operations of process flow 200. For example, process flow 200 may be performed by RO platform 110, end-user system(s) 130, or combinations thereof.

At operation 202, an RO 203 is provided for a service event rendered on a vehicle. The RO 203 may be generated by the end-user system(s) 130 and/or RO platform 110 (e.g., through application 112B and/or application 112C as described below). In an example, RO 203 may be obtained responsive to integration with end-user system(s) 130. The RO 203 may comprise a location identifier that identifies the source of RO 203, such as an identifier of the RO source system (e.g., an end-user system 130) and/or unique identifier of the entity that created the RO 203 (e.g., a dealer, shop, etc.). The RO 203 may also comprise a timestamp of when the RO committed to the RO platform 110, such as stored at database(s) 114.

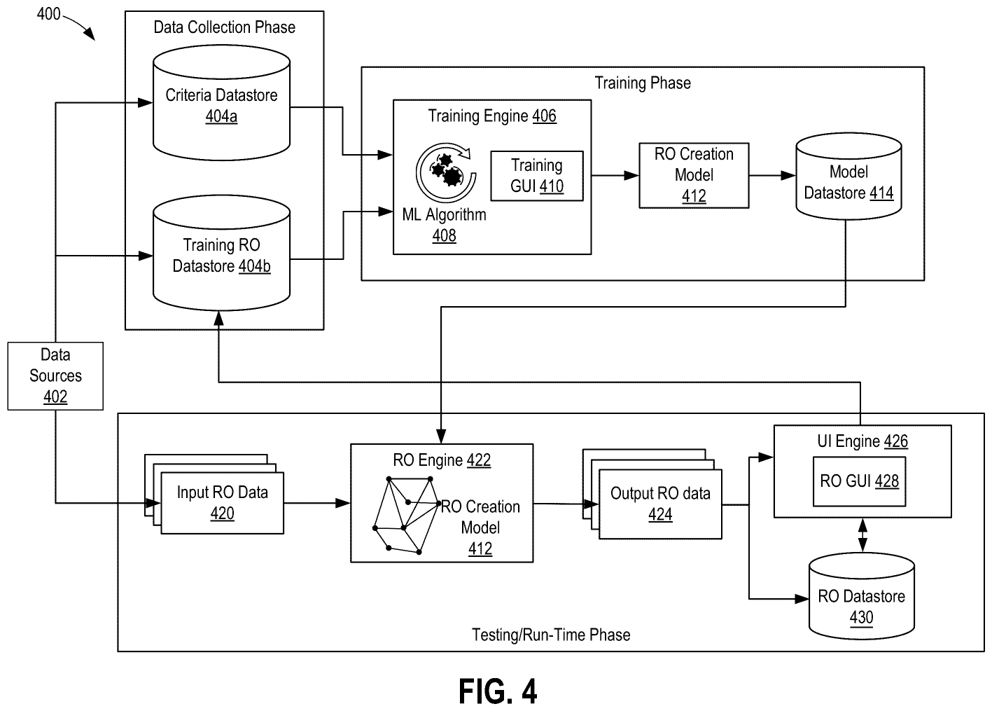

At operation 204, RO platform 110 verifies the contents of the RO 203. For example, RO platform 110 verifies that the service event provided by the RO 203 is a certified service event and that the information required for a certified service event is included in the RO 203. RO platform 110 may verify that the servicing entity is a certified entity based on the location identifier associated with the RO 203. In an illustrative example, RO platform 110 verifies that the RO 203 complies with certification compliance requirements. For example, RO platform 110 verifies that RO data contains an identifier of a Servicing Technician certified to perform the service event, identifiers of part (e.g., model numbers and/or serial numbers) that are proper for the service event according to certification compliance requirements and that all necessary parts for the service event are identified, identifiers of tools that are proper and required for the service event, identifiers that required tests were performed for the service event, identifiers that required calibrations for the service event were in place, indications that test drive(s) and/or repairs were tested after completion, and any other criteria required to meet the certification requirements of the service events. In one example, the verification performed by RO platform 110 may utilize a model trained to detect whether an input RO contains all information necessary for a certified repair, such as the RO creation model described below in connection with FIG. 4.

Once verified, the RO 203 is logged in association with a VIN for that vehicle and compiled into a block 205, at operation 206. Block 205 may be representative of code containing a cryptographic hash of the RO data for RO 203, and the VIN. In some examples, block 205 may also contain the previous block or blocks for the VIN included in the cryptographic hash.

At operation 208, block 205 is appended to an RO chain 209 of ROs for the VIN at operation 208, and the updated RO chain 209 is committed to database(s) 114 at operation 210. If block 205 is the first instance of a certified RO for the VIN, the RO chain 209 is created as the block 205 and future blocks can be appended thereto.

In some implementations, a block 205 can be generated for an RO regardless of whether the RO data is verified or not. That is, if RO platform 110 fails to verify that the RO data contains all the necessary information for certification of the service event, RO platform 110 may tag the RO data for the RO with a flag indicative that the RO failed certification and/or is incomplete. The RO data, including the certification failure tag, can then be used to compile a block 205 and append the block to the RO chain.

In some implementations, a block 205 can include information indication if an RO cleaner and/or RO writer (as described below) was executed on the RO, as well as if the end-user system 130 accepted or rejected the suggestions from the RO cleaner and/or RO writer. In this case, information indication which application was executed can be tagged to the RO 203, and compiled into the block 205 with the rest of the data. Similarly, whether or not the end-user accepted the predictive suggestions can be flagged in the RO data and compiled into block 205.

The RO chain 209 provides a history of all certified service events rendered on the vehicle corresponding to the VIN. As a result, certification of ROs (and/or failure to meet certification requirements) and tracking of historical service events can be provided on the basis of a VIN. The RO chain 209 may be provided as the VIN and a hash that identifies the code of the RO chain 209. The hash records the recent block 205 and the previous block (or blocks).

In this way, blocks 205 and RO chain 209 can lock or otherwise secure RO data from subsequent alterations, thereby providing confidence in the tracking and reporting of RO related events. RO chain 209 can provide aspects of a private and public permissionless system, allowing system operators to control who can access specific data stored in the RO chain, and what data will be opened up publicly. For example, private transactions and records may not be made public, but can be verified when needed, such as by allowing access through a smart contract built into the RO chain 209 for a VIN. Smart contracts may be built into individual blocks and/or into the RO chain 209 in the entirety as code. The smart contract may define access criteria, which may be used to verify and authenticate access via external systems 140 to data contained in the RO chain 209.

Through the use of the RO chain 209 (and smart contracts built therein in some cases), confidential information may be maintained within the RO platform 110, while remaining verifiable by external systems 140. For example, an external system 140 may access an RO, and/or interact with a RO chain via a VIN, but may not be permitted to alter data contained therein. In some implementations, external systems 140 may only be permitted to add to the RO chain by adding one or more blocks for new ROs.

Further, the application 112A can provide a “chain of custody” for ROs starting with the RO source system and ending at downstream stakeholder, through encoding for entities into various blocks of the chain. For example, a RO chain 209 can be appended with one or more blocks each representing an instance of access to the chain 209 by any systems, such as end-user system(s) 130 and/or external systems 140. In another example, a block may be appended that represents a determination (e.g., related to a warranty claim, insurance claims, or the like). In yet another example, a block may be appended that represents inquires, access, and/or offers by a compliance system 140A and/or marketplace partner systems 140B.

Returning to FIG. 1 and as alluded to above, RO platform 110 may comprise applications 112A and 112B, which may provide for automated creation and correction of ROs according to processing routines for stakeholder systems 140C. For example, applications 112A and 112B may be driven by AI that leverages an RO creation model trained to automatically populate data field entries of an RO with data and/or recommend data for entry according to processing routines defined by rules and polices from downstream stakeholder systems. The trained RO creation model may accept inputs into the RO creation model and, based on the processing routines used to define the RO creation model, output RO data. The RO data may comprise an RO that is acceptable in accordance with rules and policies corresponding to the processing routines.

RO platform 110 can be configured to create processing routines on a stakeholder basis. That is, RO platform 110 can create a processing routine corresponding to a given stakeholder system according to the rules and policies of the stakeholder associated with the given stakeholder system 114C. For example, RO platform 110 can comprise one or more applications (e.g., one or more of applications 114) in the form of code or software that ingests rules and/or policies from a stakeholder system 114C and compiles the information into a processing routine program for that stakeholder. For example, rules and policies ingested by the RO platform 110 for a stakeholder system 140C may contain a number of data elements and the RO platform 110 can compile those data elements to generate a processing routine having that number of data elements. In another example, the processing routine may contain additional data elements, such as from another external system 140, appended to the rules and polices. For example, the additional elements may include NHTSA data or other data that is not stored or tracked in a RO data generated by a conventional RO source system. In this case the application that creates the processing routine may be customized for processing routines that need additional data in order to operate.

As will be described in greater detail below, generating RO data can be accomplished over the course of multiple phases: a collection phase, a training phase, optional testing phase, and a run-time phase.

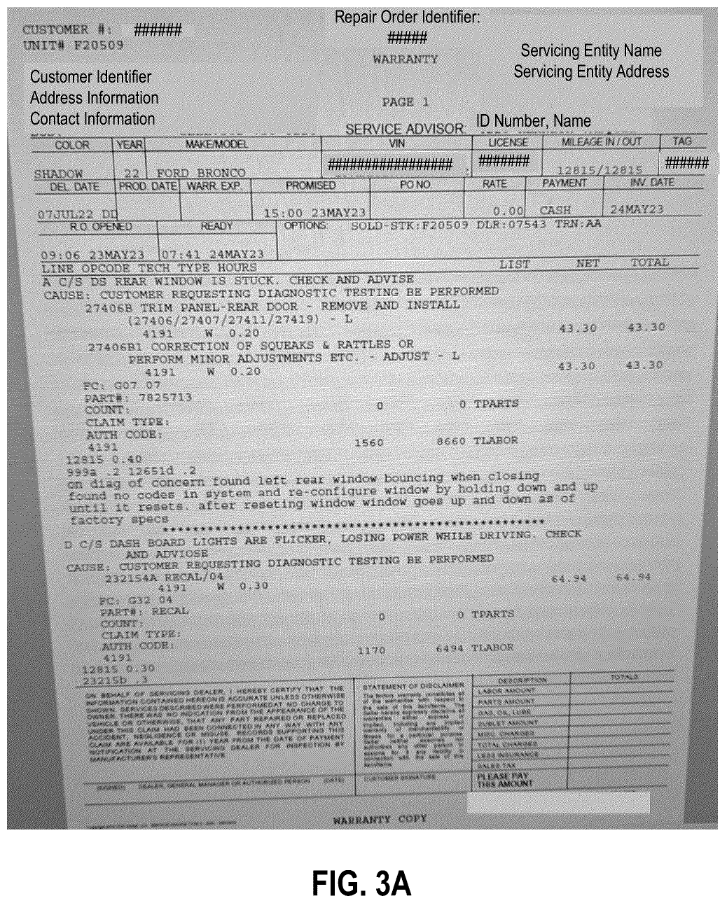

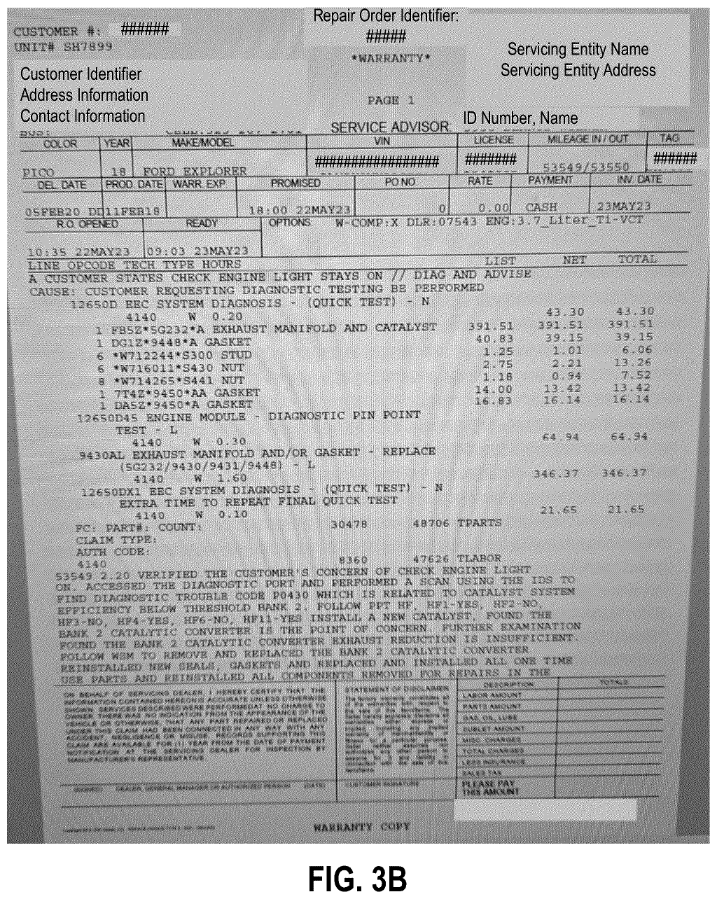

During the collection phase, training parameters and training data can be committed to datastores from data sources. The training parameters may include data and information that can be used to constrain the training, for example, by defining what is an acceptable or unacceptable RO. The training parameters may be criteria information that is based on processing routines of one or more downstream stakeholder systems. The criteria information may be defined by the rules and polices of each stakeholder. The training data can include RO data of acceptable and unacceptable ROs. FIGS. 3A and 3B depict examples of unacceptable and acceptable RO stories, respectively.

During the training phase, the RO creation model is trained based on the data collected during the collection phase. For example, a machine learning (ML) algorithm is applied to a the training data, according to the training parameters, to generate the RO creation model. ML can refer to methods that, through the use of algorithms, are able to automatically extract intelligence or rules from training data sets and capture the same in informative models. In turn, those models are capable of making predictions based on patterns or inferences gleaned from other data input into a trained model. Thus, embodiments disclosed herein constrain a RO creation model according to the training parameters that define what the RO creation model is to consider an acceptable and unacceptable RO, and then train the model on the training data.

During the run-time phase, the trained RO creation model can be executed by applications 112A and/or 112B to automatically guide creation and completion of an RO. For example, application 112A may receive inputs from an end-user into an RO in real-time while the end-user is preparing the RO. Application 112A, responsive to the inputs, applies the inputs to a trained RO creation model, which outputs suggestions and guidance, in real-time, for entry into an RO according to what is considered an acceptable RO based on the training. As a result of the training, the output RO will be acceptable according to the stakeholders rules and polices that were the basis of the training parameters. Application 112A may be referred to as a RO Writer application, which can present predictive responses to personnel in the process of preparing an RO in real-time and in line with an input via a graphical user interface (GUI) or via an end user application enhancement developed atop an API. For example, application 112A may process information of an RO and predictively suggest information that should be included in the RO. As an illustrative example, a Service Technician might not know that that there's an insurance claim related to a RO being prepared and that the insurance company wants to know certain things for processing the claim for reimbursement. In this case, application 112A may be implemented to prompt the Service Technician, while preparing the RO, to include the necessary information. Accordingly, follow ups for information request can be avoided since the resulting RO will be complete and acceptable for completing the claim.

Application 112B (sometimes referred to herein as an RO Cleaner application) operates in a similar manner to application 112A, except that application 112B receives a previously prepared RO as input—which may contain any number of defects—and applies the input RO to the trained RO creation model. In this case, the RO creation model processes the information contained in the RO and outputs an acceptable RO. For example, defects can be detected and corrected by augmenting the information to generate an updated RO that is acceptable according to the rules and polices of the stakeholders that served as the basis for the training parameters.

As a result of either application 112A or 112B, downstream stakeholder systems 140C can receive acceptable ROs according to their rules and polices. In some examples, an RO completed through application 112A may be processed by application 112B as a check.

FIG. 4 is a schematic representation of an example system 400 for generating an RO creation model in accordance with an embodiment of the present disclosure. System 400 is provided as a number of modules that may be embodied as one or more software modules executable by one or more hardware processors, e.g., as application 112A and/or 112B discussed above. The modules may commit and/or retrieve data to datastores, which may be example implementations of one or more of database(s) 114 and/or 134.

As shown in FIG. 4, during the data collection phase, data sources 402 commit data to datastores 404a and 404b to build training datasets and parameter datasets. Data sources 402 may include, for example, end-user system(s) 130 and/or stakeholder systems 140C.

Training datasets comprises RO data consisting of a number of ROs and the information documented therein. The ROs may include acceptable and unacceptable ROs, such as the illustrative examples shown in FIGS. 3A and 3B, for various of service events. Additionally, one or more acceptable and one or more unacceptable ROs may be provided for the same, similar and/or related service events. The same service event may refer to two or more service events corresponding to the same service and/or repair on the same vehicle (e.g., same VIN). A related service event refers to two or more service events that are connected in some manner, for example, a first service event and a follow-up event, a second event that is a result of the cause of the first event, and so on. Similar service events may refer to a similar type of or same service and/or repair on a same vehicle type (e.g., make and model), but not necessarily the exact same vehicle. Acceptable and unacceptable ROs may be provided for different services events and/or related service events. Training datasets may be committed to datastore 404b by end-user system(s) 130, for example, operated by a system administrator or other end-user.

As described above, parameter datasets can include criteria information that can be used to constrain the training, for example, by defining what is an acceptable or unacceptable RO. The criteria information can be based on processing routines of one or more downstream stakeholder systems defined by the rules and polices of the corresponding stakeholders. For example, criteria information may be information for evaluating whether an RO is acceptable or not according to rules and polices of a particular stakeholder. Thus, criteria information may be dependent on particular stakeholders, and varied therebetween according to the rules and policies of each stakeholder. The criteria information for a respective stakeholder can be extracted from processing routines of the stakeholder systems for the respective stakeholder. The processing routines, which are configured at the RO platform 1110, are defined according to rules and policies for evaluating ROs by that stakeholder. Criteria information may be committed to datastore 404a by RO platform 110, in one example, in the form of processing routines and/or criteria information itself. The processing routine can be processed by system 400 to derive specific criteria for each committed processing routine.

In an example implementation, a stakeholder, such as an OEM, can set forth policies and rules based on its relationship with a Dealer. In the case of an OEM and Dealer relationship, the Dealer may be required to follow these rules/policies. As described above, a processing routine is something that RO platform 110 creates to assist a Dealer with creating ROs. In some examples, RO platform 110 can create processing routines for complying with rules and policies set forth by the stakeholders. In other examples, processing routines can be unrelated to a stakeholders rules and policies and procedures. As an example, a Dealer might choose to enact a processing routine for an Insurance Provider so that ROs have all the information the insurance provider requires, not necessarily for the purpose of processing ROs, but rather to avoid the having to deal with back and forth interactions regarding the RO. As another example, a processing routine can be created for Amazon Auto Marketplace as a marketplace partner system 140B, which would have the RO require certain information in order for the Amazon Marketplace to be able to send the Dealer offers on ROs. Processing routines may be related to rules and policies of external systems, unrelated to external systems, or a combination of both. Criteria represent specific data entries within a given processing routine. For example, rules and polices may define a field to include certain data and define a required value of data for that field in order to be acceptable. The processing routine may be representative of the rules and policies collectively, while the criteria represents the individual requirements defined by the rules and polices.

In various embodiments, an end-user (e.g., a system administrator) may operate a client application executed on end-user system(s) 130 (e.g., an example of client application 132) for building the training dataset and/or parameter datasets. For example, the end-user may select one or more processing routines to be used to constrain the RO creation model. Based on the selected processing routines, parameter datasets can be built by pulling the criteria information for the selected processing routines into one or more parameter datasets. In one example, a distinct parameter dataset may be built for each processing routine corresponding to a particular stakeholder, while in another example a single parameter dataset may be built for all selected processing routines. For example, a dealership may be associated with one or more OEMs (e.g., Ford, General Motors, etc.) and an end-user can then select processing routines for each warranty claim categorized according to the OEM. Similarly, an end-user may select processing routines for processing insurance claims of a given one or more insurance companies. Some processing routines may be optional (e.g., certain OEMs in the case of an independent repair shop), where others may be required (e.g., OEM in the case of a dealership). In some embodiments, selecting one processing routine, may make another processing routine mandatory due to dependencies. For example, a selection of a processing routine for a given stakeholder system, may require a generic processing routine configured to apply that stakeholders internal nomenclature to an RO so they a specific processing routine can be applied (e.g., nomenclature routine leads to a claim routine). This is just one example of many scenarios where one processing routine leads to a second. The sequence in which processing routines are ran may also be adjusted by the system based on the combination of routines selected. A training GUI 410, presented via the client application, may be provided to allow an end-user, such as a system administrator, to select processing routines and input parameters.

During the training phase, training datasets are retrieved by training engine 406 from the training RO database 404b and applied to an ML algorithm 408, which generates a RO creation model 412 trained on the training datasets according to the parameter datasets. As noted above, the parameter datasets are applied to the ML algorithm 408 to constrain the RO creation model according to the criteria information contained in the parameter datasets, thereby defining what is an acceptable or unacceptable RO according to the rules and polices that defined the criteria information.

Once parameter datasets are applied to the ML algorithm 408, the training datasets are applied to the constrained ML algorithm 408 to train the model and generate the RO creation model 412. The ML algorithm 408 may be provided as an AI computation resource library (such as, but not limited to, TensorFlow, Open AI, ChatGPT, etc.) that define ML algorithms. ML algorithms may be any algorithm known in the art, for example but not limited to, supervised learning algorithms leveraging labeled data (e.g., classification algorithms, regression algorithms, and the like where training ROs are labeled as true/acceptable or false/unacceptable); unsupervised learning algorithms (e.g., classification algorithms, regression algorithms, and the like where training ROs are unlabeled), reinforcement learning algorithms, among others. The training engine 406 outputs the RO creation model 412 and commits the RO creation model 412 to a model datastore 414, which may be an example of database(s) 114 of FIG. 1.

During the training phase, the ML algorithm 408 compares various combinations of the training datasets to learn what is an acceptable and unacceptable RO according to the parameter datasets. For example, ML algorithm 408 can compare unacceptable ROs with acceptable ROs for the same, similar or related service events; compare unacceptable ROs with acceptable ROs for different service events; compare a first one or more acceptable ROs with a second one or more acceptable ROs for the same, similar or related service event; and compares a first one or more acceptable ROs with a second one or more acceptable ROs for different service events.

Through the training phase, the RO creation model 412 learns what is an acceptable RO compared to an unacceptable RO. For example, RO creation model 412 learns generic corrections, such as words, terms, phrases, and codes that are specific to the parameter dataset. In an illustrative example, ML algorithm 408 compares words, terms, phrases and codes present in an RO to a proprietary database of words commonly used in the relevant industry (e.g., jargon, abbreviations, short-hand, equivalent codes, etc.) to build vocabulary data for the RO creation model 412. The RO creation model 412 can also learn proper spelling and grammar according to known correct spelling and grammar rules for vocabulary above. Furthermore, RO creation model 412 can learn story formatting structure for ROs through the various comparisons.

Additionally, the RO creation model 412 learns to recognize and correct processing routines based on the comparison of the various ROs. For example, electronic ROs contain a number of data entry lines that each represent an individual part of an overall server event, for example, as shown in the illustrative examples in FIGS. 3A and 3B. Each data entry line can comprise at least one data entry field in which data (or values) that can be entered and a corresponding identifier descriptive of the information to be entered into the field. That is, for example, an identifier may indicate to an end-user what type of information is to be entered in a corresponding field, and the end-user may then enter the information (e.g., contents of the story) into the field. The RO creation model 412 may can learn, on a line by line basis, which fields are required based on the identifier and according to the criteria information. The RO creation model 412 also learns, according to the criteria information, whether a value entered into the field is allowable, adjustable, and whether the value can be adjusted to improve an outcome of the processing of the RO. RO creation model 412 can also learn whether a field of a data entry line is used correctly, for example, whether the value is appropriate and in which way to adjust the value if inappropriate for the service event. As another example, RO creation model 412 can learn to recognize if a diagnostic test was performed, and if so was the information properly entered and acceptable according to the criteria information. The RO creation model 412 can learn information related to rental or loaner vehicle policies and learn acceptable entries for such. RO creation model 412 can learn to recognize Service Technician time entries and whether they are acceptable according to the criteria information. RO creation model 412 can learn to determine if an OEM scorecard processing routine is enabled (e.g., based on the processing routines selected above) and learns rules related to the OEM scorecard for processing the RO. In some embodiments RO creation model 412 can learn to recognize critical service events for inclusion on the RO chain, described above in connection with FIG. 2. Through the learning the RO creation model 412 can learn to recognize a complete story of 3 C's, for example, by considering ROs as a whole to learn necessary components and data entries to document an acceptable story. Furthermore, the RO creation model 412 can also learn RO lines/Job lines; sublet repairs, correction codes/warranty operation codes; odometer reading; shop supplies; and parts.

Once RO creation model 412 is trained, operationalization functions can be executed that deploy a RO engine 422 comprising the trained RO creation model 412 onto RO platform 110, for example, as a separate application 112N or as a part of one or more of application 112A and/or application 112B. The RO engine 422 can be executed by RO platform 110 for evaluating and recommending information for inclusion in an RO. For example, data sources 402 may supply input RO data 420 to RO engine 422. RO engine 422 applies the input RO data to the RO creation model 412, which processes the RO data according to the training and outputs RO data 424. The RO engine 422, through execution of RO creation model 412, evaluates the input RO data 420 and makes determinations on the data contained in the input RO data on whether the RO data is acceptable or not. If the input RO data is acceptable, the RO creation model 412 passes the input RO data 420 downstream as output RO data 424. However, if RO engine 422 determines that the input RO data 420 or a portion thereof is not acceptable, the RO engine 422 attempts to correct the input RO data 420 by adjusting values of the input RO data 420 to an acceptable value. The corrected RO is then output as RO data 424. In some embodiments, if RO engine 422 cannot make a correction that would make the RO acceptable, the RO engine 422 can flag the output RO data 424 for further evaluation at a UI engine 426. Output RO data that is deemed acceptable, either by the RO engine 422 or UI engine 426 may be committed to an RO datastore 430 for storage in RO platform 110 and/or use by downstream stakeholder systems 140C. RO datastore 430 may be an example of a database 114. In one example, a block of an RO chain can be created for a committed RO responsive to deeming the RO as acceptable.

In an illustrative example, RO engine 422 can be executed by application 112B (e.g., the RO Cleaner application). In this case, the input RO data 420 may comprise data of a previously prepared RO, for example, prepared by an end-user at end-user system(s) 130. The RO engine 422 applies the prepared RO to the RO creation model 412 and corrects, cleans, augments the prepared RO according to the criteria information. The corrected RO is then supplied as output RO data 424. If RO engine 422 cannot fix an issue on the input RO data 420, RO engine 422 may flag the concern in the output RO data and forward the concern to the end-user, for example, through an RO GUI 428 ran by UI engine 426, for corrective actions. For example, client application 132 on end-user system(s) 130 may generate RO GUI 428 as an thin, thick, or otherwise client for reviewing and editing the concern as necessary. Flagged items can be accompanied by notes, comments and other feedback, such as, but not limited to, marked as “critical” or “non-critical” so the RO engine 422 can decide whether to address the issue or not. Concerns may be critical (e.g., where the RO will fail a downstream stakeholder processing routing) or non-critical (e.g., where the RO will pass the downstream processing routine but may be non-compliant with certain downstream processing routines). Some of the downstream processing routines may require varying degrees of information based on OEM scorecards, which change over time. Thus, RO engine 422 can be configured to adjust corrections to ROs responsive to the changes in the OEM scorecards.

In another example, RO engine 422 can be executed by application 112A (e.g., the RO Writer application). In this case, the input RO data 420 may comprise one or more entries into a field of an RO, which can be provided to RO engine 422 in real-time (e.g., as the end-user is entering the data into an RO in an end-user system 130). Here, the RO engine 422 applies the entry as input RO data 420 to the RO creation model 412, which processes the entry and generates predictive recommendations on information to be entered into the field according to the criteria information. In some embodiments, the entry and previously entered data can be supplied to the RO engine 422 as the input, such that RO engine 422 can make predictive recommendations when considering the input as a whole. The generated recommendation can be provided to the end-user as output RO data 424 and provided to the end-user through RO GUI 428, in line with the field for which the input RO data 420 corresponds. In another example, predictive recommendations can be presented out of line as needed, such as where a section of information may be required for processing an insurance claim that the RO drafter was unaware of. Thus, RO engine 422 can guide the end-user through creation and completion of an RO according to stakeholder rules and polices, thereby ensuring that the resulting RO is complete and accurate according to the stakeholder. In some embodiments, RO engine 422 can highlight (or otherwise bring end-user attention to) required fields and/or missing information. For example, during RO creation, RO engine 422 may highlight or otherwise emphasis required fields. As another example, RO engine 422 may recognize the end-user skipped a required field, for example, by detecting the end-user entering data into a field below a required field, and highlight or otherwise emphasis the skipped field. Once an RO is completed, the RO can be stored in RO datastore 430.

In either case, as part of the processing of input RO data 420, the RO engine 422 attempts to make corrections to input RO data 420 where appropriate. Corrections can be grouped into generic corrections and processing routine corrections. After the processing of input RO data 420 is complete, output RO data 424 may be supplied to UI engine 426 to determine if resulting ROs are actually acceptable or not. Thus may include review by an end-user via the RO GUI 428. Any ROs that remain unacceptable can be added to an exception que and fed back into datastores 404b as RO data for re-training RO creation model 412 for improved future outcomes.

Example generic corrections include, but are not limited to, corrections to wording, spelling, grammar, and/or story structure or formatting. For example, RO creation model 412 compares words, terms, phrases and codes present in an input RO data 420 to the vocabulary data. RO engine 422 then updates the input RO data 420 as needed based on the comparison. As another example, RO engine 422 can correct the spelling of words in input RO data 420 by correcting words based on proper spelling and/or corrects them to an appropriate abbreviation or equivalent term that is acceptable according to downstream stakeholder needs. In yet another example, RO engine 422 can correct grammar by adjusting grammar in input RO data 420 to reflect standard grammar with consideration given to vocabulary data. In another example, RO engine 422 can adjust the structure or formatting of the story by transforming the story into an acceptable format/structure according to structure requirements set forth by the RO platform 110 and/or stakeholder systems 140C.

Example processing routine corrections can include a wide variety of corrections, a non-exhaustive list of examples is provided herein. However, processing routines may be defined according to stakeholder needs, and thus may be both industry and stakeholder specific. In any case, RO engine 422 process input RO data 420 based on processing routines selected as described above.

According to some embodiments, RO engine 422 considers data entry lines, including fields, identifiers, and data (e.g., values) entered into each field, on a field by field basis. RO engine 422 can determine whether certain fields are required according to the processing routines and whether the field requires a value to be present therein. RO engine 422 can determine if the value present is allowable according to the processing routines and whether the value present can be adjusted to improve an outcome for the RO (e.g., improve a likelihood of acceptance by the stakeholder). For example, time spent on a repair by a Service Technician, costs to customer, or amount of time permitted for a rental or loaner vehicle may be adjustable. If the value is adjustable and is determined to not be allowable, RO engine 422 can adjust the value to an acceptable value where appropriate. RO engine 422 can also determine whether a field is used correctly. For example, RO engine 422 can determine if a data entered into a field is appropriate according to processing routines, and adjust the data if it is determined to be inappropriate.

Further, in some embodiments, RO engine 422 evaluates diagnostic tests information of an input RO data 420 (e.g., part of the Cause of the 3 C's). For example, RO engine 422 can determine if a diagnostic test is required according to processing routines and whether data is provided indicating that a diagnostic test was performed. RO engine 422 can also determine if results of the diagnostic test result are acceptable in view of the Correction performed and according to the processing routines. RO engine 422 can be implemented to create a flag and/or comment if diagnostic test is missing from input RO data 420 or the values are not acceptable. Furthermore, RO engine 422 can evaluate other parts of input RO data 420 to determine if data for a diagnostic test information is present but at a improper location within the RO and move the data to a correct location. This action of moving data from a wrong location to a correct location is not limited to only diagnostic test data, but can be performed on any data that may be located at an improper location.

Further, in some embodiments, RO engine 422 can consider rental and/or loaner vehicle processing routines. For example, RO engine 422 can determine if a rental or loaner vehicle is permitted based on the service event and according to processing routines for the service event. For example, certain services events (as documented by the 3 C's) may not warrant a rental vehicle due to the length of time for completing the service. Thus, based on the service event and the stakeholder rules and policies, a determination can be made by RO engine 422 on whether or not a rental vehicle is permitted. RO engine 422 can also determine if a rental or loaner vehicle was provided, and if the amount of time the rental or loaner vehicle was provided exceeds an allowable amount based on the service event (e.g., was the rental or loaner vehicle provided for more time than allowable in a labor time guide that defines allowable time for a repair). RO engine 422 can remove or adjust the data regarding the rental or loaner vehicle as appropriate according to stakeholder rules and policies. If a rental or loaner vehicle is allowed, but data is missing from input RO data 420, the RO engine 422 can generate a flag and/or comment on the RO indicating that data is missing.

RO engine 422 may also evaluate Service Technician time entries contained in input RO data 420. For example, RO engine 422 can determine if an RO requires a time recording from the Service Technician based on stakeholder rules and policies, and, if required, determine whether or not data of indicative of a time entry is present in the input RO data 420. RO engine 422 can determine if the time recorded exceeds the time allowable in the labor-time guide, or is below the time allowable in the labor-time guide. RO engine 422 can also adjust the time recorded to an allowable amount according to the stakeholder rules and policies.

As noted above, certain fields and data entered into an RO may be impacted by OEM scorecards. In this case, RO engine 422 can consider whether an end-user enabled the OEM Scorecard processing routine, for example, at training GUI 410. If enabled, RO engine 422 can apply the rules related to the OEM scorecard and processes the input RO data 420 with consideration given to the OEM scorecard rules.

In some cases, certain fields and data entries of an RO may be impacted due to the service event being or related to a certified repair. In this case, RO engine 422 can evaluate the input RO data 420 to determine if the type of repair is critical and appropriate for inclusion in the RO chain, as described above in connection with FIG. 2. If critical, RO engine 422 can determine whether or not the input RO data 420 includes all necessary data, such as information on Certified Technician IDs, parts, tools, tests, calibrations and other criteria required to meet the standards of the stakeholders. If the input RO data 420 contains the required information, or RO engine 422 can correct input RO data 420 to contain the required information, RO engine 422 can mark the output RO data 424 as Compliant and add the output RO data 424 to the RO chain (e.g., RO chain 209). Otherwise, if the input RO data 420 does not include the information needed and input RO data 420 is not able to correct it, RO engine 422 can flags the resulting output RO data 424 as “Non-Compliant” and generate annotations on the output RO data 424 as to missing information and basis for the flag.

RO engine 422 may also consider the RO as a whole to evaluate whether the input RO data 420 contains necessary information to provide a complete and acceptable story as documented by the 3 C's. In this regard, RO engine 422 can evaluate all of contents of the input RO data 420 as a whole to determine whether or not the components necessary for a complete story are present. That is, is there a Complaint, a Cause, and a Correction, and necessary information to acceptably document each. Evaluation of the 3 C's may include one or more of the previously described determinations, such as considerations on fields, considerations on diagnostic tests, etc. If RO engine 422 determines elements are missing, RO engine 422 can attempt to add/correct each missing or incorrect element. If, after making corrections, RO engine 422 can determine if the story is complete and accurate. If not, RO engine 422 can rerun any combination of processing routines until the story is complete and acceptable. If RO engine 422 cannot correct the input RO data 420 so to provide a complete and accurate story, RO engine 422 can flag the resulting output RO data 424 and generate annotations embedded into output RO data 424 for review by the end-user (e.g., at RO GUI 428).

Other example considerations include, but are not limited to, RO lines/Job lines (e.g., the individual data entry lines within an RO, which can have individual repair items addressed); sublet repairs (e.g., subcontracting out part of a service event); correction codes/warranty operation codes (e.g., codes from labor time guides that correspond to work performed); odometer reading; shop supplies (e.g., non-inventory items used in the repair of a vehicle); and parts.

Table 1 below provides a non-exhaustive list of stakeholder and corresponding processing routines that can be used to exact criteria information as parameter datasets as part of the training phase.

TABLE 1

| Processing | | Re-training |
|---|---|---|
| Routine | Parameters | Inputs |
| OEM Warranty | These routines can define what is | Post-processing can include |
| Rules/Policies | expected in an RO as related to | review of exceptions that do not |
| | processing an OEM Warranty | meet the minimum criteria set |
| | Claim related to (a) getting the | forth by the OEM Warranty Rules |
| | RO claim paid and (b) reducing | and Policies. Corrective inputs |
| | the risk of the RO being used to | can be made that can then fed |
| | trigger an audit/chargeback from | back into the training to further |
| | the Dealer. | refine the Processing Routine for |
| | These rules can include which | future incidents of the exception. |
| | fields are required, the level of | |
| | documentation/back-up required | |
| | in the form of attachments | |
| | (Rental Car Receipts, Test | |
| | Results, Damage Photos, etc. | |
| OEM | OEMs scorecards can be | Post-processing can include |
| Scorecards | published by the OEM and report | review exceptions that do not |
| | on the effectiveness of a Dealer | meet the minimum criteria set |
| | using a variety of criteria | forth by the OEM Warranty Rules |
| | including, but not limited to, RO | and Policies. Corrective inputs |
| | accuracy, Customer Satisfaction | can be made that are then fed |
| | levels, etc. | back into the training to further |
| | OEM scorecard results can result | refine the Processing Routine for |
| | in a temporary adjustment to the | future incidents of the exception. |
| | Base OEM Warranty Rules and | |
| | Policies, as well as can result in | |
| | the imposition of additional | |
| | documentation and compliance | |
| | requirements from Dealers. | |
| | The OEM Scorecard can be used | |
| | to adjust the criteria required by | |
| | an RO based on the Scorecard | |
| | Requirements. The adjustments | |
| | made can be more strict or more | |
| | relaxed depending on the | |
| | Scorecard Criteria. | |
| | As an example, a superior OEM | |
| | Scorecard may exempt the | |
| | dealer from having to include a | |
| | rental car receipt in the RO. An | |
| | inferior OEM Scorecard may | |
| | require a rental car receipt. | |
| | OEM Scorecards change over | |
| | time, and the system can adjust | |
| | the criteria as change in the OEM | |
| | Scorecard scores occur. | |
| Insurance | Insurance Companies establish | Post-processing can include |
| Rules/Policies | criteria necessary to assure that | review exceptions that do not |
| | repair performed on a vehicle are | meet the minimum criteria set |
| | performed correctly and in | forth by the Insurance |
| | accordance with claim payouts | Industry/Company's Rules and |
| | made on a vehicle. | Policies. Corrective inputs can be |
| | | made that are then fed back into |
| | | the training to further refine the |
| | | Processing Routine for future |
| | | incidents of the exception. |
| Critical | The base parameters can be | N/A |
| Repairs | defined by the VIN of a vehicle, | |
| | and determined when a repair is | |
| | performed on any of the vehicle's | |
| | critical systems or systems | |
| | affecting a critical system. | |
| | “Critical Systems” are most often | |
| | related to ADAS repairs including | |
| | but not limited to; | |
| | Navigation system | |
| | Adaptive Cruise Control | |
| | Adaptive Light Control | |
| | Vision Enhancement | |
| | Speed limit assistance | |
| | Curve speed assistance | |
| | Dangerous spot warning | |
| | Stop and go | |
| | Forward collision assistance | |
| | Rear collision assistance | |
| | Lane change assistance | |
| | Self-driving/Autonomous | |
| | driving systems | |
| | Emergency braking | |
| | Pedestrian detection | |
| | Collision avoidance | |
| | Traffic sign recognition | |
| | Lane departure warning | |
| | Cross traffic alert | |
| | Surround view | |
| | Digital side mirror | |
| | Digital rear view mirror | |
| | Blind spot detection | |
| | Park assist | |
| | Rear Collision warning | |
| | However, critical systems can be | |
| | affected when non-critical | |
| | systems are serviced/repaired | |
| | and affect a Critical system. | |
| | An example of this would be | |
| | when a windshield is broken and | |
| | requires replacement. While the | |
| | windshield is just glass, the | |
| | sensors affecting radar cruise | |
| | control housed in the mirror, that | |
| | look through the glass, must be | |
| | recalibrated in conjunction with | |
| | the windows replacement. | |
| | Another example would include a | |
| | mirror being replaced, where the | |
| | sensor and camera in the mirror | |
| | used for lane change assist and | |
| | parking assist would require the | |
| | replacement of the correct parts | |
| | and have the overall system | |
| | calibrated post replacement of | |
| | the mirror itself. | |
| Other | Other sets of base parameters | New training may be introduced, |
| Stakeholders | may be provided as new | either at initial training or re- |
| | stakeholders and stakeholder | training, to address exceptions |
| | rules and policies are identified. | that do not meet the minimum |
| | | criteria set forth by the new |
| | | stakeholder Rules and Policies. |
| | | Corrective inputs can be made |
| | | that are then fed back into the |
| | | training to further refine the |
| | | Processing Routine for future |
| | | incidents of the exception. |
| Other | The RO record may be verified | |
| Routines | and augmented by third party | |
| | data to ensure its validity or to | |
| | enhance the RO record for the | |
| | purpose of enabling a Processing | |
| | Routine, or make the RO record | |
| | actionable to a Marketplace | |
| | Partner. | |
| | Third Party Data Sources can | |
| | include, but are not limited to; | |
| | OEM Data | |
| | Dealer Data | |
| | National Highway Traffic | |
| | Safety Administration Data | |
| | CarFax and other Vehicle | |
| | History Tracking Website Data | |
| | VIN decoding software Data | |
| | Recall database Data | |
| | Service bulletin database Data | |
| | Other relevant data related | |
| | to the VIN and/or its | |
| | service and repair history | |

In some embodiments, output RO data 424 can be tagged with an identification that the RO has been processed by RO engine 422. The tag can be stored as metadata with the output RO data 424 and used by external systems 140 as confirmation that the RO is acceptable. In some implementations, identifiers of the processing routines used to define the RO engine 422 may be included in the metadata as well so that external systems 140 may confirm for which processing routines the output RO data 424 is acceptable.

FIG. 5 is a schematic block diagram of an operating environment 500 for integrating an RO platform 510 with RO source system 504. For example, FIG. 5 depicts an RO source system 504, which may be an example implementation of an end-user system 130. Thus, similar to end-user system(s) 130 shown in FIG. 1, RO source system 504 can be accessed by end-users via client applications 502A-502N (collectively referred to herein as client applications 502), each of which may be executed locally on an end-user computing device. Client applications 502 may function as frontend systems for interfacing with an RO source backend system 504. As noted above, client applications 502 may be operated as thin, thick, or anywhere therebetween.

In an example implementation, the RO source system 504 may be a DMS and each client applications 502 may be dealership DMS client application executed on, for example, a computing device of the dealership. However, any RO source system may be implemented as any end-user system, such as an SMS and the like. Client applications 502 may be located at the same geographic area or be distributed across various geographic locations.

The RO source system 504 may be communicatively connected to a RO platform 510, which may be substantially similar to RO platform 110 of FIG. 1. As such, RO platform 510 may comprise one or more applications 512 that can be executed by the RO platform 510. For example, one or more applications 512 may access an RO engine 516, which may be substantially similar to RO engine 422 of FIG. 4. Thus, RO engine 516 may comprises a trained RO creation model. RO engine 516 may create and/or augment input RO data to generate acceptable ROs that can be committed to RO datastore 518 (e.g., RO datastore 430 of FIG. 4). Further details on operations of RO engine 516 and one or more applications 512 are provided above in connection with FIG. 4.

RO source system 504 may comprise a marketplace 504A, where third parties or other entities may offer integrated platforms. For example, an entity may offer platforms through an API or OTA that can be installed on to the RO source system 504 and accessed by client applications 502 via a RO source system gateway 504B. The RO source system gateway 504B may be implemented as APIs or OTAs of the RO source system 504 according to some examples.

Through the marketplace, client applications 502 may sign up for access to RO platform 510, and the RO source system 504 then provides access to the RO platform 510 for an account associated with the requesting client applications 502. That is, for example, each client applications 502 may correspond to a disparate dealership each having an associated account with the RO source system 504. Client application 502A of a first dealership may sign up for access to RO platform 510, which causes RO source system 504 to provide the requesting dealership access to RO platform 510 through RO source system gateway 504B.

Upon providing access to RO platform 510, end-user data—which can include RO data—from client application 502A can be provided to RO platform 510 through RO source system gateway 504B. In various embodiments, responsive client applications 502 Referring to the above example, dealership data may be provided from client application 502A to RO platform 510 through RO source system gateway 504B as a set of APIs. Using the RO source system gateway 504B, RO platform 510 can pull data from the client applications 502. For example, once a client application 502 is integrated into RO platform 510, ROs can be obtained from the integrated client application 502 and stored in RO datastore 518 as a central repository.

In various examples, one or more applications 512 can be executed on the RO data obtained from the client application 502. For example, through RO Writer application and/or RO Cleaner application as described above, an RO can be created and/or corrected through execution of RO engine 516 to generate acceptable ROs, which can be stored in RO datastore 518. In some examples, updated ROs can be provided back to client application 502 via the RO source system gateway 504B. Client application 502 may be displaying a GUI (e.g., RO GUI 428) through which an end-user can review, evaluate, and otherwise monitor the update ROs as described above.

Client applications 502 need not be end-users in all cases. For example, client applications 502 may be implemented as a client application 142C of stakeholder systems 140C. Through a similar process described above, stakeholder systems 140C can thus gain access to RO platform 510 for obtaining ROs committed to RO datastore 518. Stakeholder systems 140C may then execute processing routines on the ROs to process rules and policies for making determinations on the ROs.

In some embodiments, end-users and/or stakeholders may be using RO source system 504 without access to marketplace 504A. In this case, these entities may not be integrated into or otherwise unable access RO platform 510 via RO source system gateway 504B. Instead, these entities may access a web service that generates a UI 514. Through UI 514, an end-user system(s) 130 may upload one or more batches of ROs on which one or more applications 512 can be executed to correct the batches of RO, which can be stored in RO datastore 518. For example, in the example of FIG. 5, client application 502B may not have access to the marketplace 504A, in which case client application 502B access RO platform 510 through the UI 514. Similarly, stakeholders and other third parties may be permitted to access ROs stored in RO datastore 518 through the UI 514.

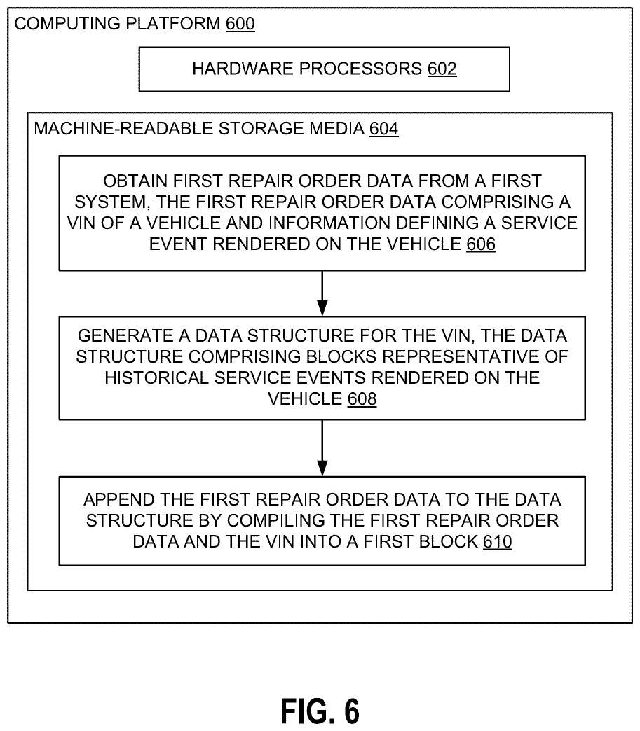

FIG. 6 illustrates an example computing component that may be used for repair order management in accordance with various embodiments. Referring now to FIG. 6, computing component 600 may be, for example, a server computer, a controller, or any other similar computing component capable of processing data. In the example implementation of FIG. 6, the computing component 600 includes a hardware processor 602, and machine-readable storage medium for 604.

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-610, to control processes or operations for repair order management. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 604 may be a non-transitory storage medium, where the term “non-transitory”does not encompass transitory propagating signals. As described in detail below, machine-readable storage medium 604 may be encoded with executable instructions, for example, instructions 606-610.

Hardware processor 602 may execute instruction 606 to obtain first repair order data from a first system. The first repair order data comprising a VIN of a vehicle and information defining a service event rendered on the vehicle.

Hardware processor 602 may execute instruction 608 to generate a data structure for the VIN, the data structure comprising blocks representative of historical service events rendered on the vehicle. The data structure may be an RO chain as described above in connection with FIGS. 1 and 2.

Hardware processor 602 may execute instruction 610 to append the first repair order data to the data structure by compiling the first repair order data and the VIN into a first block. Accordingly, a second system, such as an external system 140, may access the data structure using the VIN to locate the data structure and track service events rendered on the vehicle.

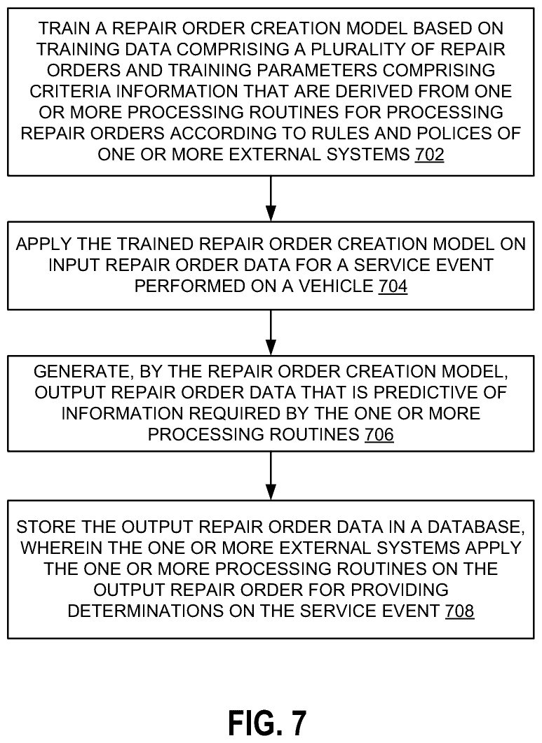

FIG. 7 is flow diagram of example process for generating repair orders in accordance with the implementations disclosed herein. The process of FIG. 7 may be provided as instructions stored in memory, which may be executed by a processor for performing the operations 702-708 of FIG. 7.

At operation 702, a repair order creation model can be trained based on training data. As described above, training data can comprise a plurality of repair orders and training parameters. The training parameters may include criteria information derived from one or more processing routines for processing repair orders according to rules and polices of one or more external systems.

At operation 704, the trained repair order creation model can be applied on input repair order data for a service event performed on a vehicle.

At operation 706, output repair order data can be generated by the repair order creation model that is predictive of information required by the one or more processing routines.

At operation 708, the output repair order data can be stored in a database. The one or more external systems can then apply the one or more processing routines on the output repair order for providing determinations on the service event.

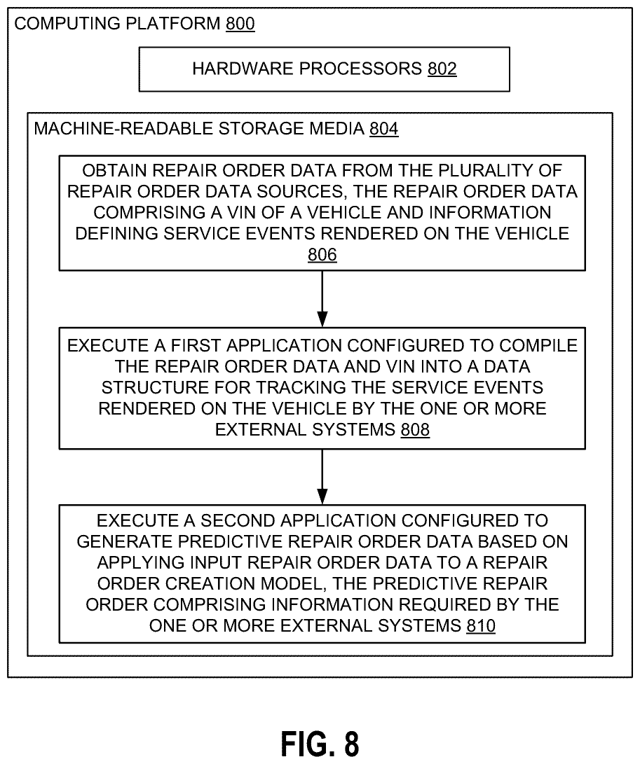

FIG. 8 illustrates an example computing component that may be used for synchronization repair orders in accordance with various embodiments. Referring now to FIG. 8, computing component 800 may be, for example, a server computer, a controller, or any other similar computing component capable of processing data. In the example implementation of FIG. 8, the computing component 800 includes a hardware processor 802, and machine-readable storage medium for 804.

Hardware processor 802 may be one or more central processing units (CPUs), semiconductor-based microprocessors, and/or other hardware devices suitable for retrieval and execution of instructions stored in machine-readable storage medium 804. Hardware processor 802 may fetch, decode, and execute instructions, such as instructions 806-810, to control processes or operations for repair order synchronization. As an alternative or in addition to retrieving and executing instructions, hardware processor 802 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 804, may be any electronic, magnetic, optical, or other physical storage device that contains or stores executable instructions. Thus, machine-readable storage medium 804 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 804 may be a non-transitory storage medium, where the term “non-transitory” does not encompass transitory propagating signals. As described in detail below, machine-readable storage medium 804 may be encoded with executable instructions, for example, instructions 806-810.

Hardware processor 802 may execute instruction 606 to obtain repair order data from a plurality of repair order data sources. The repair order data comprises a VIN of a vehicle and information defining service events rendered on the vehicle. The repair order data sources may be communicatively coupled (e.g., via a wired or wireless network) to a cloud-based server and a plurality of

Hardware processor 802 may execute instruction 608 to generate a data structure for the VIN, the data structure comprising blocks representative of historical service events rendered on the vehicle. The data structure may be an RO chain as described above in connection with FIGS. 1 and 2.

Hardware processor 802 may execute instruction 810 to execute a second application configured to generate predictive repair order data based on applying input repair order data to a repair order creation model, the predictive repair order comprising information required by the one or more external systems.

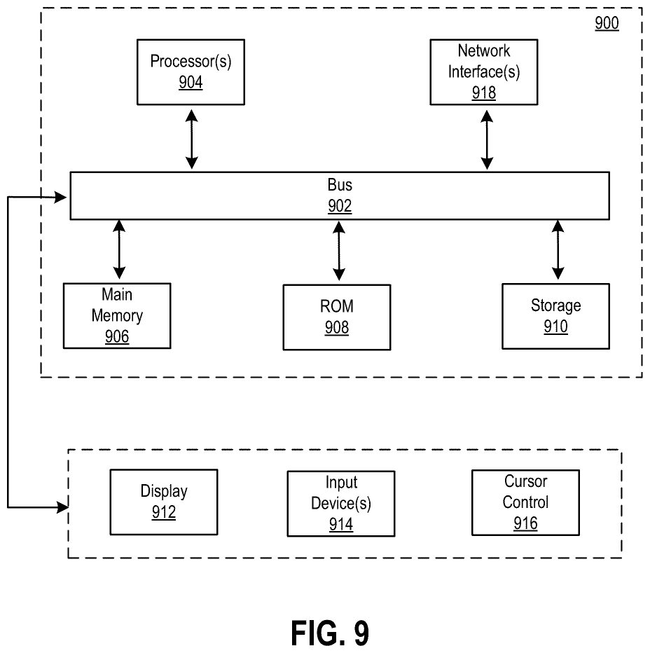

FIG. 9 depicts a block diagram of an example computer system 900 in which various of the embodiments described herein may be implemented. Computer system 900 may be an example implementation of one or more of RO platform 110, end-user system(s) 130, and/or external systems 140 of FIG. 1. The computer system 900 includes a bus 902 or other communication mechanism for communicating information, one or more hardware processors 904 coupled with bus 902 for processing information. Hardware processor(s) 904 may be, for example, one or more general purpose microprocessors.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

The computer system 900 may be coupled via bus 902 to a display 912, such as a liquid crystal display (LCD) (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. In some embodiments, the same direction information and command selections as cursor control may be implemented via receiving touches on a touch screen without a cursor.

The computing system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

The computer system 900 also includes a communication interface 918 coupled to bus 902. Network interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or WAN component to communicated with a WAN). Wireless links may also be implemented. In any such implementation, network interface 918 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 918, which carry the digital data to and from computer system 900, are example forms of transmission media.

The computer system 900 can send messages and receive data, including program code, through the network(s), network link and communication interface 918. In the Internet example, a server might transmit a requested code for an application program through the Internet, the ISP, the local network and the communication interface 918.

The received code may be executed by processor 904 as it is received, and/or stored in storage device 910, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 900.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A cloud-based platform system, the platform system comprising:
a memory configured to store instructions; and
at least one processor communicatively coupled to the memory, the at least one processor configured to execute the instructions to:
obtain first repair order data from a first system, the first repair order data comprising a vehicle identification number (VIN) of a vehicle and information defining a service event rendered on the vehicle;
generate a data structure for the VIN, the data structure comprising blocks representative of historical service events rendered on the vehicle; and
append the first repair order data to the data structure by compiling the first repair order data and the VIN into a first block;
wherein a second system accesses the data structure using the VIN to track service events rendered on the vehicle.

2. The platform system of claim 1, wherein the at least one processor is further configured to:
obtain second repair order data from a plurality of repair order source systems, the repair order data comprising the VIN and information defining the historical service events rendered on the vehicle,
wherein generating the data structure comprises compiling the second repair order data and VIN into the blocks.

3. The platform system of claim 1, wherein the at least one processor is further configured to:
obtain third repair order data from a plurality of repair order source systems, the repair order data comprising a plurality of VINs for a plurality of vehicles and information defining a plurality service events rendered on the plurality of vehicles; and
for each VIN of the plurality of VINs, generate a data structure by compiling information defining service events rendered on a vehicle corresponding to each VIN.

4. The platform system of claim 1, wherein the at least one processor is further configured to:
determine that the service event is certified service event based on the first repair order data; and
wherein appending the first repair order data to the data structure is responsive to the determination.

5. The platform system of claim 4, wherein the determination comprises verifying that the first repair order data comprises identification data of a certifier technician, certified parts, certified tools, certified tests, certified calibration.

6. The platform system of claim 1, wherein the at least one processor is further configured to:
responsive to obtaining the first repair order data, transmitting a notification to the second system.

7. The platform system of claim 6, wherein the at least one processor is further configured to:
responsive to an input from the second system, tag the block with.

8. The platform system of claim 6, wherein the block is provided as code comprising a hash of the first repair order data and the VIN.

9. A method for generating repair orders, the method comprising:
training a repair order creation model based on training data comprising a plurality of repair orders and training parameters comprising criteria information that are derived from one or more processing routines for processing repair order according to rules and polices of one or more external systems;
applying the trained repair order creation model on input repair order data for a service event performed on a vehicle;
generating, by the repair order creation model, output repair order data that is predictive of information required by the one or more processing routines; and
storing the output repair order data in a database, wherein the one or more external systems apply the one or more processing routines on the output repair order for providing determinations on the service event.

10. The method of claim 9, wherein the training data comprises a first plurality of repair orders that are acceptable according to the rules and policies of the one or more external systems and a second plurality of repair orders that are unacceptable according to the rules and policies of the one or more external systems.

11. The method of claim 9, further comprising:
receiving the input repair order data in real-time as part of preparing a repair order for the service event at an end-user system.

12. The method of claim 9, further comprising:
receiving, from an end-user system, the input repair order data comprising a repair order for the service event,
wherein the input repair order data is applied to the trained repair order creation model responsive to receiving the input repair order data.

13. The method of claim 9, wherein training the repair order creation model comprises:
constraining a machine learning model using the training parameters to teach the machine learning model; and
applying the training data to the constrained machine learning model to generate the trained repair order creation model.

14. The method of claim 9, further comprising:
establishing communicative connections to a plurality of end-user systems; and
responsive to establishing communicative connects, obtaining repair order data from each of the plurality of end-user systems,
wherein the repair order data is applied to the trained repair order creation model as the input repair order data.

15. A repair order synchronization system, the repair order synchronization system comprising:
a cloud-based server communicatively coupled to a plurality of repair order data sources and one or more external systems, the cloud-based server configured to:
obtain repair order data from the plurality of repair order data sources, the repair order data comprising a vehicle identification number (VIN) of a vehicle and information defining service events rendered on the vehicle;
execute a first application configured to compile the repair order data and VIN into a data structure for tracking the service events rendered on the vehicle by the one or more external systems; and
execute a second application configured to generate predictive repair order data based on applying input repair order data to a repair order creation model, the predictive repair order comprising information required by the one or more external systems.

16. The repair order synchronization system of claim 15, wherein obtaining the repair order data from the plurality of repair order data sources is responsive to establishing communicative connections with the plurality of repair order data sources.

17. The repair order synchronization system of claim 15, wherein the obtained repair order data is stored in a cloud-based database.

18. The repair order synchronization system of claim 15, wherein the first application is further configured to create a block from the VIN and the repair order and append the block to the data structure, wherein the data structure is a chain blocks representing prior repair orders for the VIN.

19. The repair order synchronization system of claim 15, wherein the second application is further configured to train the repair order creation model based on training data comprising a plurality of repair orders and training parameters comprising criteria information that are derived from one or more processing routines for processing repair orders according to the one or more external systems.

20. The repair order synchronization system of claim 15, wherein the input repair order data is at least one of: input repair order data received in real-time as part of preparing a repair order, and input repair order data comprising a completed repair order for the service event.
